(19) United States
(12) Patent Application Publication
(10) Pub. No.: US 2010/0223155 A1
(43) Pub. Date: Sep. 2, 2010

(54) ONLINE SYSTEM FOR COLLABORATIVE PUBLISHING AND COMMERCE

(76) Inventors: John S. Anderson, Portola Valley, CA (US); Robert D. Ralian, Milwaukee, WI (US); Richard Lorbach, Waukesha, WI (US)

Correspondence Address: DORSEY & WHITNEY, LLP;INTELLECTUAL PROPERTY DEPARTMENT, 370 SEVENTEENTH STREET, SUITE 4700, DENVER, CO, 80202-5647, US

(21) Appl. No.: 12/610,001

(22) Filed: Oct. 30, 2009

Related U.S. Application Data
(60) Provisional application No. 61/110,570, filed on Nov. 1, 2008.

(51) Int. Cl. G06F 3/048; G06Q 20/00; G06Q 30/00; G06Q 50/00; G06F 15/16

(52) U.S. Cl. 705/27; 715/752

(57) ABSTRACT

An online system for managing collaborative greeting cards, gift cards, and guest books comprising an interface system including a creator interface and a contributor interface for creating the card and contributing to the card. The system may further include a messaging system, for circulating invitations to contribute signatures, messages, and other media to the card, notify contributors of card status, and/or deliver the card to a recipient and/or notify recipient of the card and/or gift. The system may further include a payment system for contributing to a group gift and/or create an individual gift.

### CROSS-REFERENCE TO RELATED APPLICATIONS

This application claims the benefit of priority under 35 U.S.C. §119(e) of U.S. Provisional Application No. 61/110,570 entitled Online System for Collaborative Publishing, filed Nov. 1, 2008, which is hereby incorporated herein by reference in its entirety.

### BACKGROUND OF THE INVENTION

The present invention is in the technical field of Internet software. More particularly, the present invention is in the technical field of Internet communication, publishing, printing, gifting, and greetings.

### BRIEF SUMMARY OF THE INVENTION

One aspect of the present invention is an online system which allows users to create and add different types of media and then add that media to a shared online and printable template such as a greeting card or guest book. Furthermore, the system includes a payment processing, messaging, and interface system that allows multiple users to collaborate and/or collectively pay for a single greeting or gift.

Another aspect of the present invention involves a unique interface and process which aids collaboration and expression in a way that makes users likely to collaboratively participate and therefore create a more desirable end product, such as a group greeting card, gift, or guest book.

### BRIEF DESCRIPTION OF THE DRAWINGS

FIG. 1 describes the core flows of one embodiment of the present invention;

FIG. 2 describes numerous sub components with one embodiment of the present invention;

FIG. 3 is an illustration of an exemplary collaborative product, in this case a greeting card with a cover and two pages of user contributions;

FIG. 4 is an illustration of a gift card with a message from contributors;

FIG. 5 is an illustration of the interface where a user selects a template for a card with one embodiment of the present invention;

FIG. 6 is an illustration of the interface where a user beings to sign a card with the present invention;

FIG. 7 is an illustration of the interface where a user adds and positions his message or picture to a card on the present invention;

FIG. 8 is an illustration of the interface where a user adds his part of a gift with one embodiment of the present invention;

FIG. 9 is an illustration of the interface where a user pays for his gift on one embodiment of the present invention;

FIG. 10 is an illustration of the interface where a user invites more people to participate with a card in an embodiment of the present invention;

FIG. 11 is an illustration of the interface where a user (the recipient) chooses what specific gift he will redeem on one embodiment of the present invention;

FIG. 12 and FIG. 12a is an image manipulation template whereby users can mix their own image with a template; and

FIG. 13 describes the experience of adding a message, including placement, fonts, and end result.

### DETAILED DESCRIPTION

Referring now to the figures, it is shown an overall flow of the user throughout our web service.

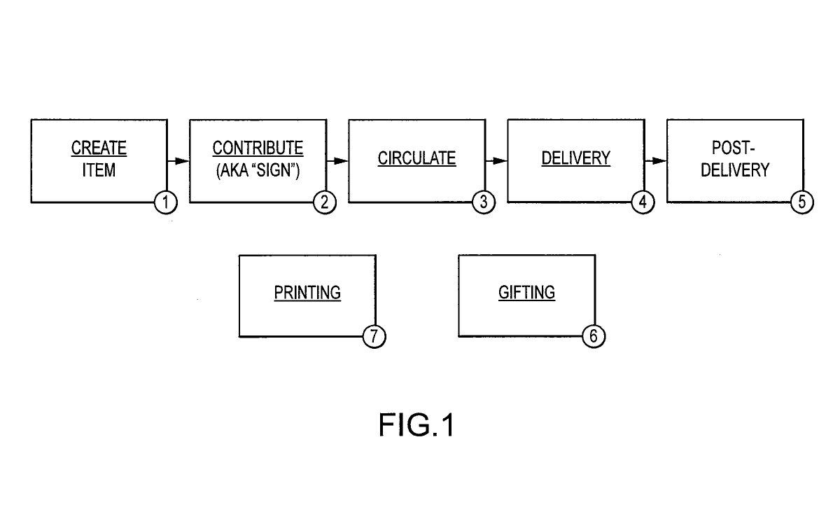

In FIG. 1, it is shown that generally each media is:
1) Created by one person, “the creator”
2) Contributed to by the creator and all contributors
3) Circulated, or spread amongst multiple contributors
4) Delivered to the recipient or the creator
5) Available for other post delivery processes such as printing, sharing, saving, or posting on other web platforms
6) Gifting is often part of the contribution flow
7) Any participant may print out the media—either order as a printed good or as a downloadable media

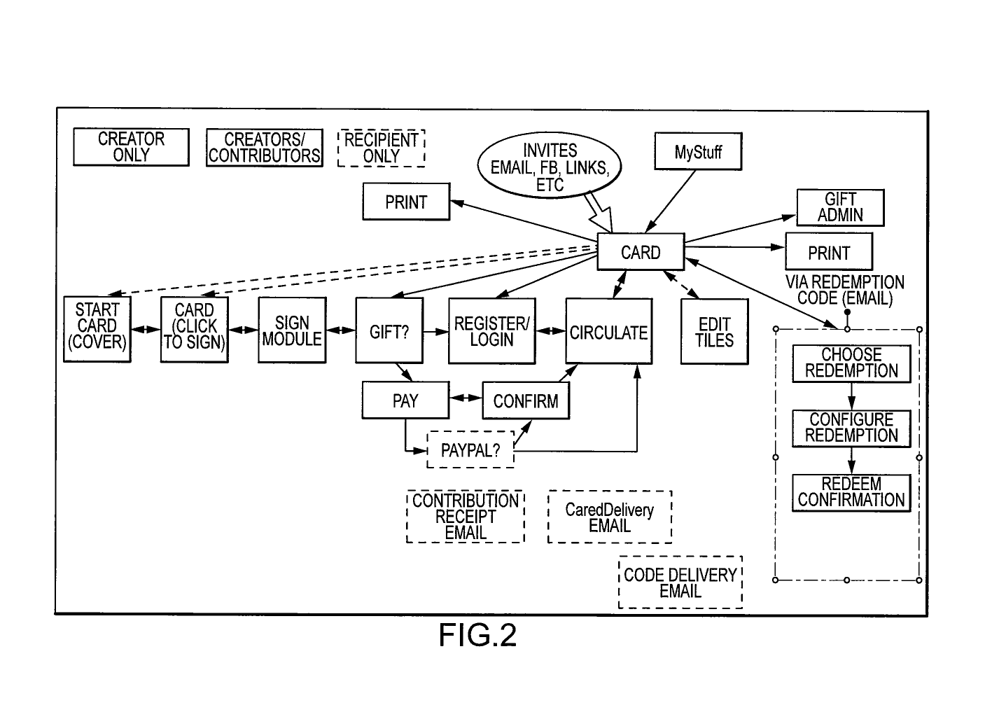

In FIG. 2, each box represents a user interface or web page. In our system, there are three types of users—creators, contributors, and recipients. Each user type will experience different interface pages and flows on our system
1) A creator is responsible for creating the card and starting and leading the collaborative process:
   a. setting the title and card layout and card template;
   b. setting the recipient information, and the date at which the card is delivered;
   c. adding his personal message to the recipient, adding his gift contribution, paying for any gift; and
   d. circulating the card to many contributors to sign the card.
2) A contributor is typically invited to sign and/or contribute a gift to the card:
   a. is invited via a secure link sent to him via email, via sms/text message, and via messages on other online platforms such as social networks. The secure link is one that is statistically impossible for another user to guess—thereby making the card accessible only to those people who are invited;
   b. starts on the card page itself, then signs the card, adds their gift, and then (optionally) may invite more people; and
   c. may access cards directly from a company website, or via links from within other web platforms. For example, a user may actually sign a card or contribute to a guest book from within another social platform which features the application described herein.
3) A recipient is the user who, on the predetermined time/date, receives the final product greeting card and/or gift card.

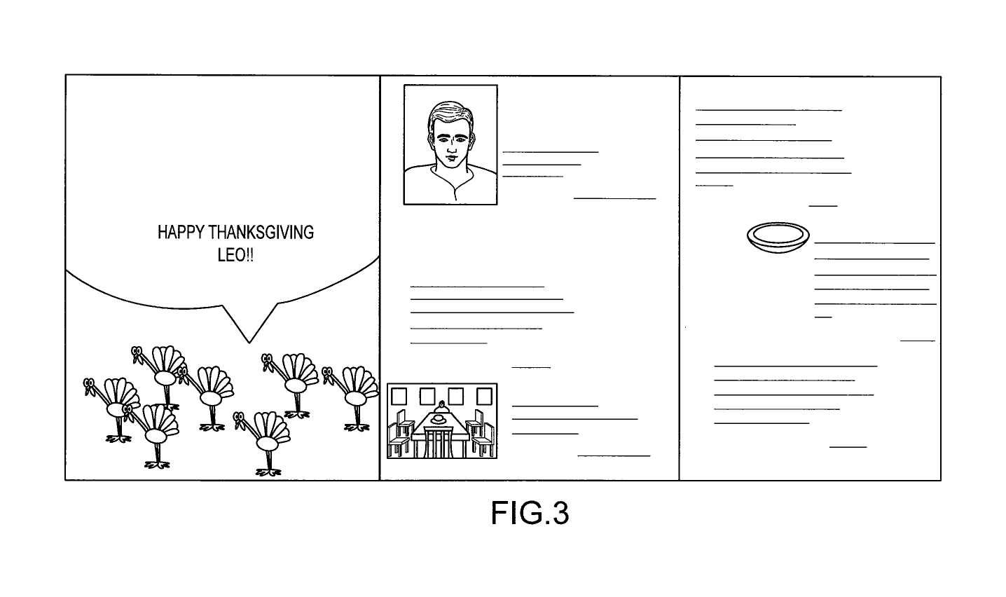

In FIG. 3 there is shown an example of a media output from the system that may be ready for delivery to a recipient. In this case the media is a card. Key attributes to note are:
a. pictures and messages contributed from different users;
b. different fonts that can be used;
c. the use of images and messages; and
d. the appearance of a fold and other elements which make the greeting card look like a physical paper greeting card, each page being unique.

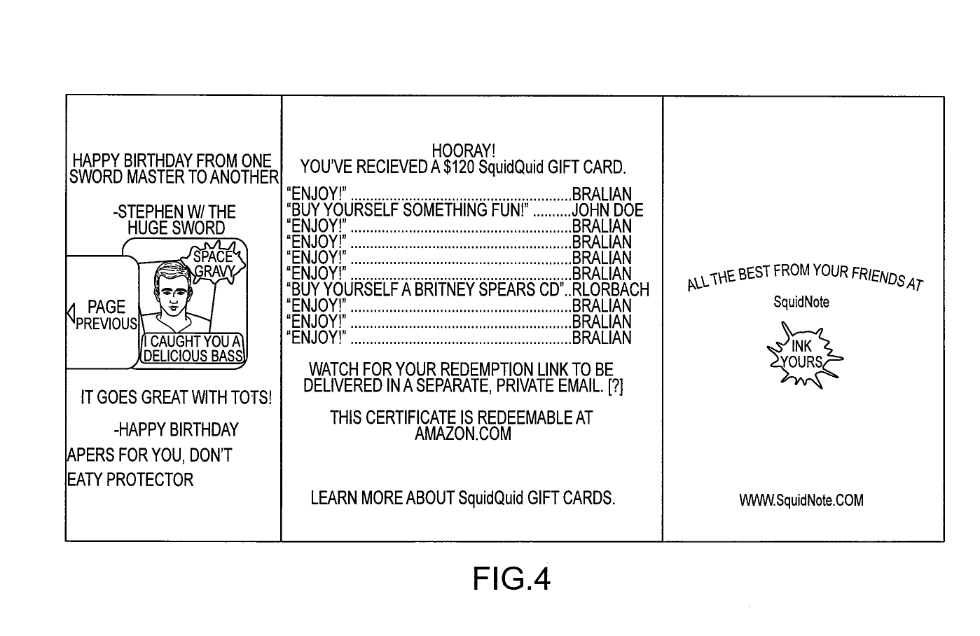

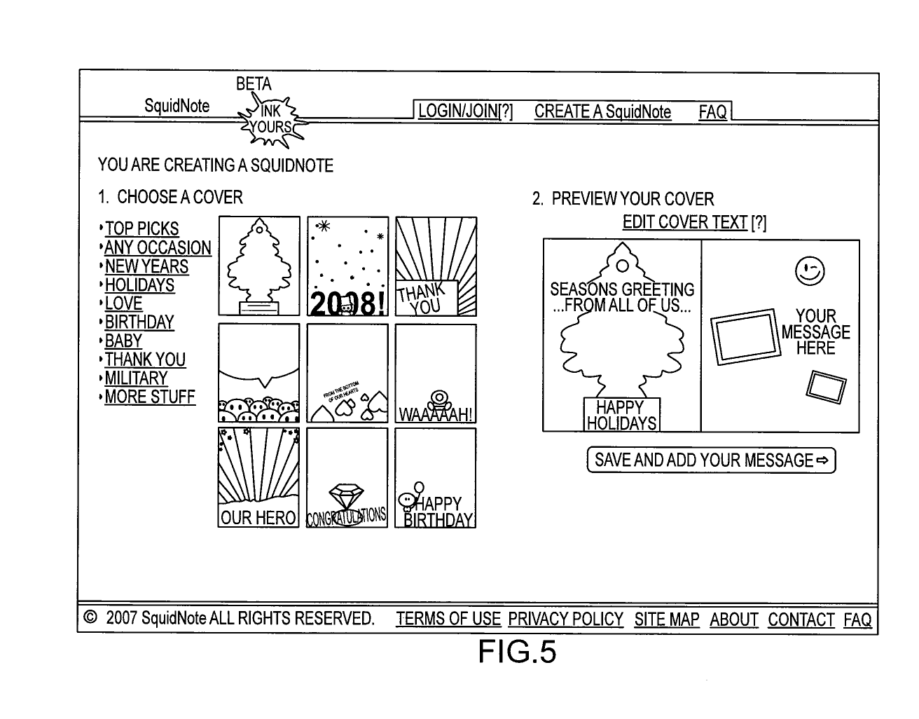

In FIG. 4 there is shown an example of a page (in a group greeting card output from the system) that shows the group gift that the recipient has received. Key attributes to note are:
a) multiple messages from different contributors;
b) a total gift amount, which represents the sum of all financial contributions made by all contributors; and
c) messaging and functionality that shows that this gift can actually be redeemed/used at the merchant of the recipients choosing

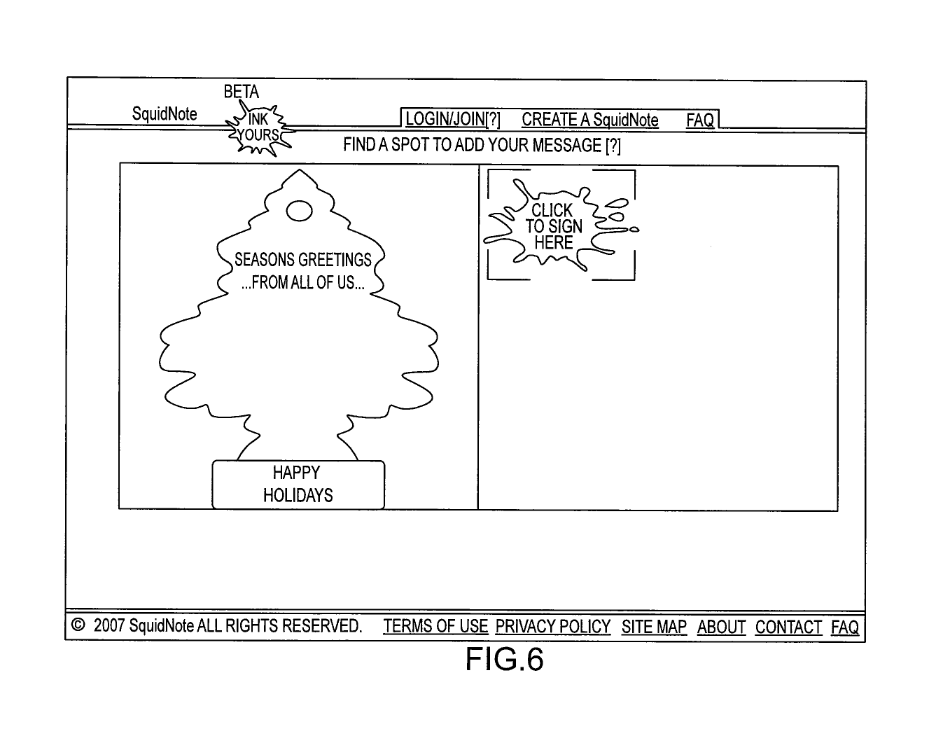

In FIG. 6 there is shown an example of a page where a user (a Contributor) can choose where on a card he may sign. The crosshairs (depicted here with “click here to sign”) move wherever the users mouse points, therefore allowing the user to click and then sign anywhere on the page he wishes. In particular, the user can click to sign somewhere that another user has not already signed.

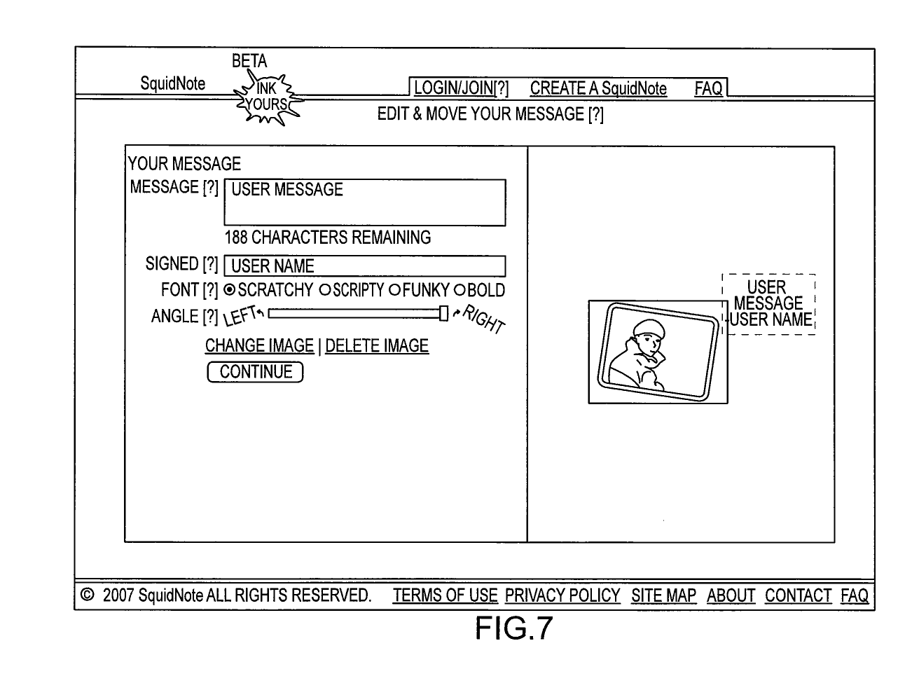

In FIGS. 7 (and 13) there is shown an example of a page where a user (a Contributor) may enter his message, signs his name, chooses a font, skews angle, and adds an image. On the right hand side of this page, the user may click to drag/drop any image or message that they add.

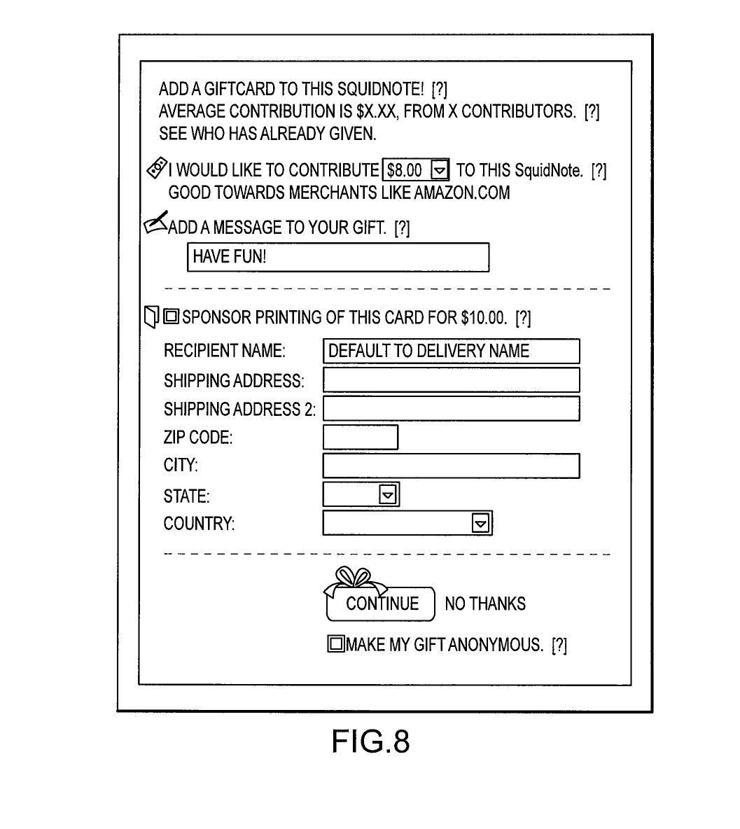

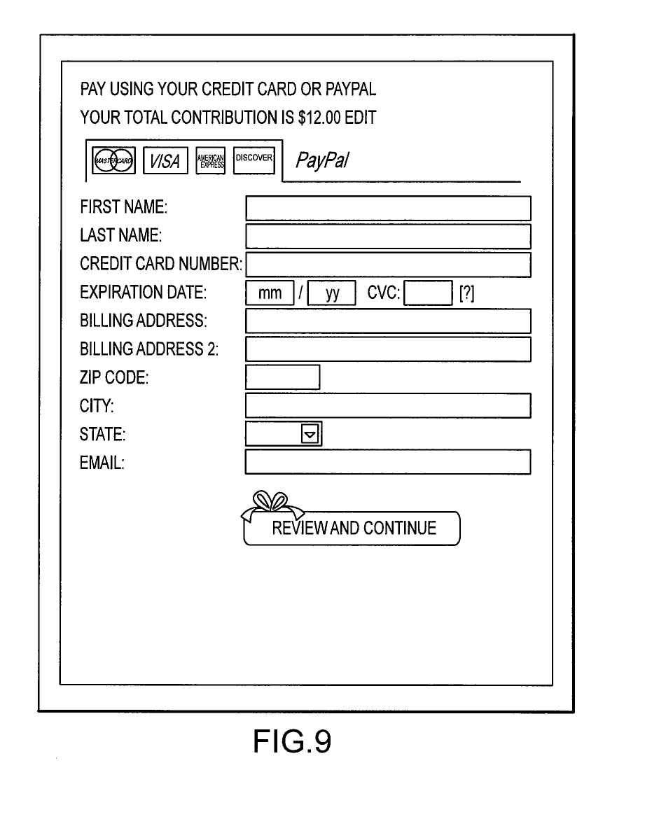

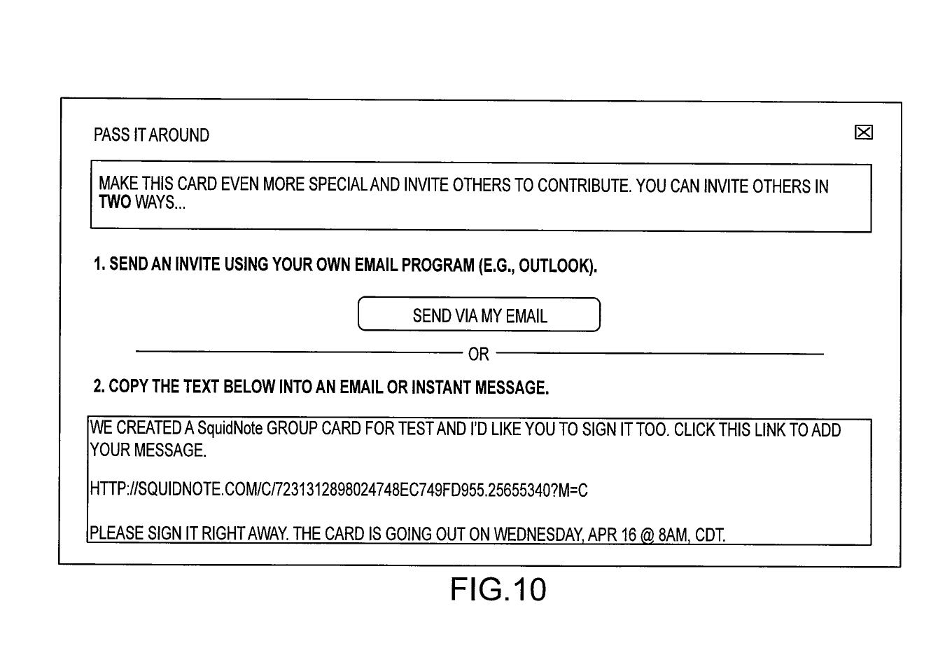

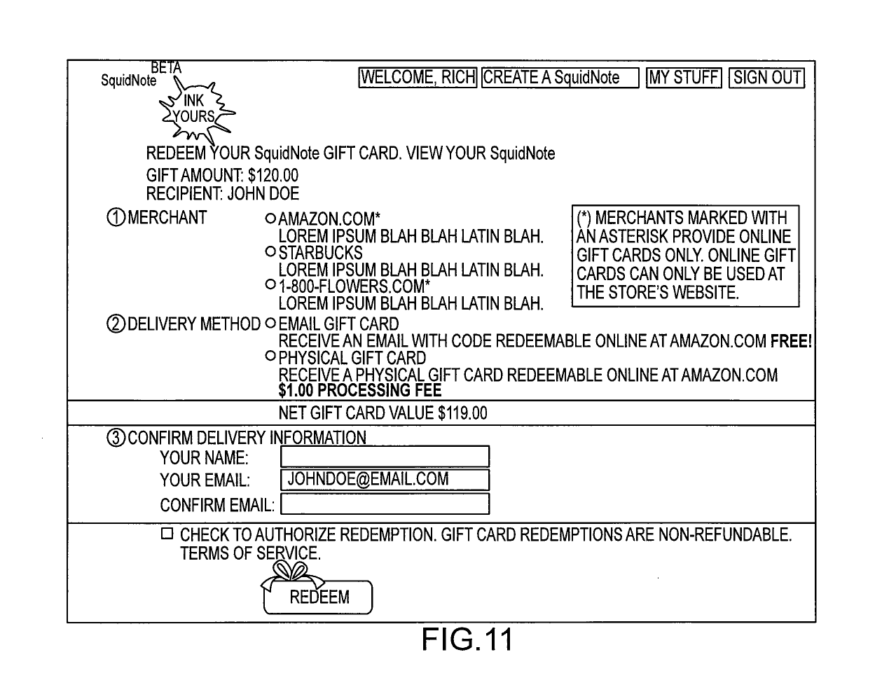

In FIGS. 8 and 9 there is shown an example of a page where a user (a Contributor) can add a gift contribution. The contribution can be part of a group gift (where all contributors contribute funds towards a combined gift, gift card, or gift currency) or an individualized gift that may be added to the card, such as a bundle of flowers or other single-giver gift.

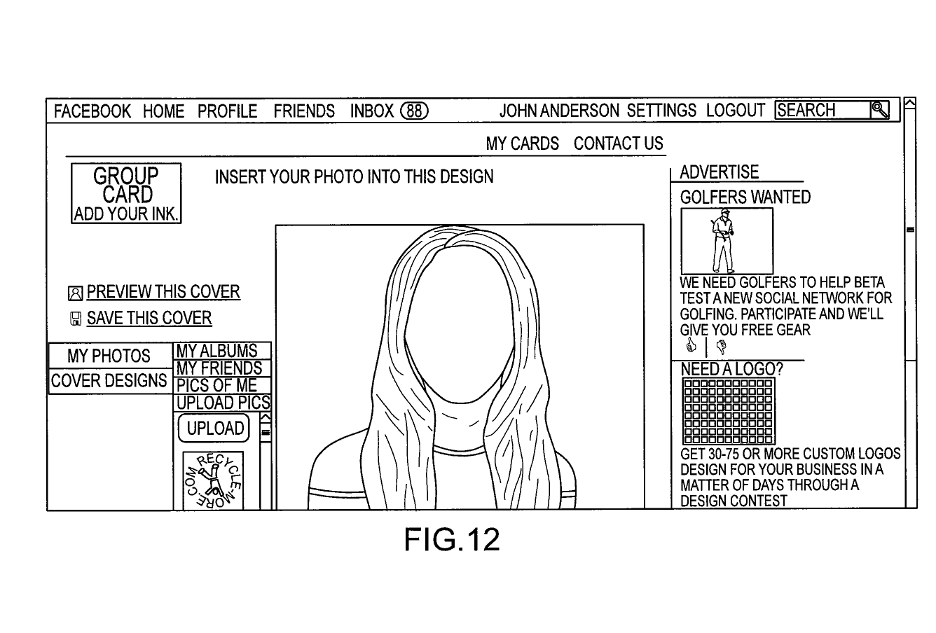

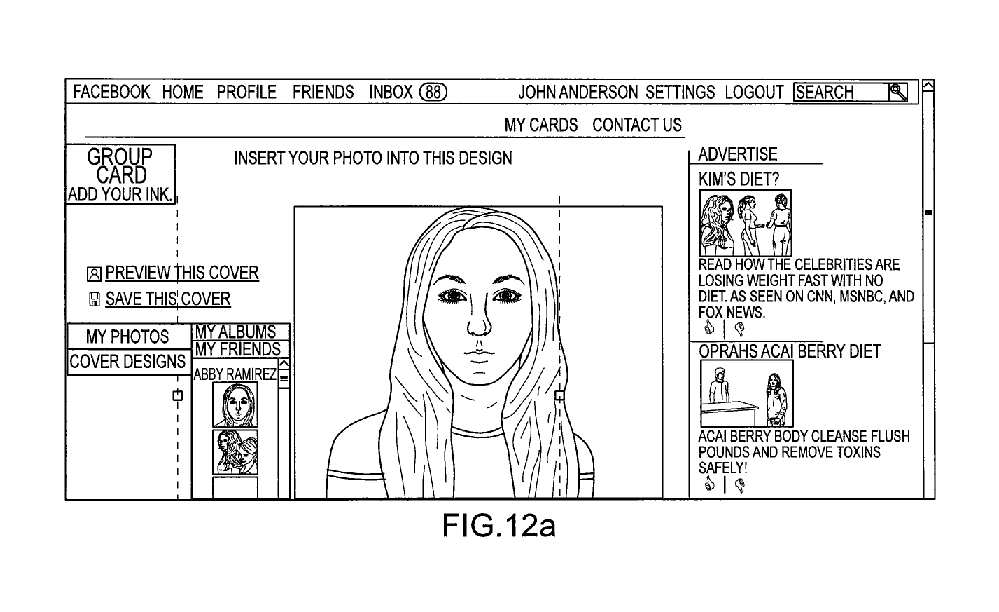

FIG. 12 illustrates a means by which a user can create a unique artwork by mixing a predefined template (in this picture, for example, a blond head shot) with the user's own image. This customization enables expression and customization of the ultimate end product.

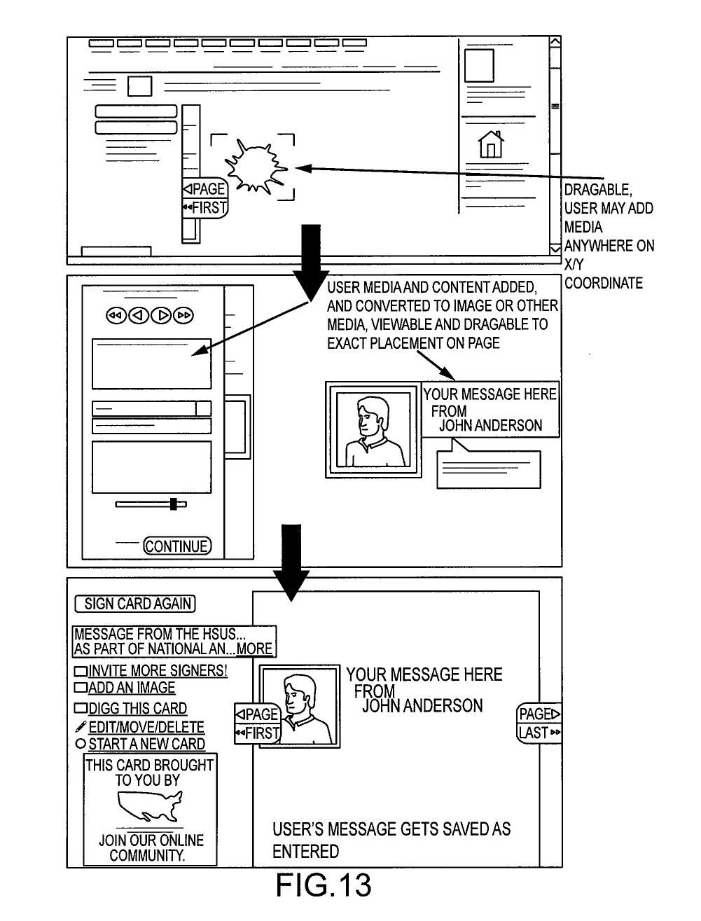

In FIG. 13 is shown a series of screens which show the user experience and interface of choosing where to place their own media, composing a text message, choosing fonts, and placing media on a page as the user wishes. Though not shown here, this interface may allow many users to blend a multitude of messages together in a very organic way.

We claim:

1. An online system for managing collaborative cards or guest books comprising;
an interface system, comprising
a creator interface for creating the card and modifying the media;
a contributor interface for contributing to the card and modifying the media;
a messaging system, wherein
the messaging system may be used to circulate invitations to contribute media, notify contributors of card status, and/or deliver the card to a recipient and/or notify recipient of the card and/or gift;
a payment system wherein
users may contribute to a group gift and/or create an individual gift.

2. An online system that allows users to create and add different types of media and then add that media to a shared online and printable template such as a greeting card or guest book, the system including:
a payment processing system,
a messaging system, and
an interface system that allows multiple users to collaborate and/or collectively pay for a single greeting or gift.

3. An interface which aids collaboration and expression in a way that makes users likely to collaboratively participate and therefore create a more desirable end product, such as a group greeting card, gift, or guest book.

4. A method of collaborating and expressing in a way that makes users likely to collaboratively participate and therefore create a more desirable end product, such as a group greeting card, gift, or guest book.
